(19) United States
(12) Patent Application Publication
(10) Pub. No.: US 2025/0083010 A1
(43) Pub. Date: Mar. 13, 2025

(54) PADDLE WITH REDUCED ACOUSTIC SIGNATURE AND IMPROVED VIBRATION DAMPING

(71) Applicant: LA Golf Partners LLC, Newport Beach, CA (US)

(72) Inventors: Jeffrey William MEYER, Fallbrook, CA (US); Tod BORETTO, San Diego, CA (US)

(21) Appl. No.: 18/830,340

(22) Filed: Sep. 10, 2024

Related U.S. Application Data
(60) Provisional application No. 63/581,927, filed on Sep. 11, 2023.

(51) Int. Cl. A63B 60/54; A63B 59/42; A63B 102/08; B32B 3/08; B32B 3/26; B32B 5/02; B32B 5/26; B32B 7/09; B32B 27/12

(52) U.S. Cl. CPC A63B 60/54; A63B 59/42; B32B 3/08; B32B 3/266; B32B 5/02; B32B 5/26; B32B 7/09; B32B 27/12; A63B 2102/08; A63B 2209/02; B32B 2260/023; B32B 2260/046; B32B 2307/72

(57) ABSTRACT

A pickleball paddle for reducing the acoustic signature caused by striking a ball and for reducing the vibrations felt by a user is presented. A pickleball paddle includes a core having first and second sides, an outer edge between the first and second sides, and holes extending through the core from the first side to the second side. The pickleball paddle also includes a first laminate layer coupled to the first side. The paddle further includes a second laminate layer coupled to the second side. The paddle also includes fibers that respectively extend through at least one of the holes, the fibers being coupled to the first and second laminate layers.

### CROSS-REFERENCE TO RELATED APPLICATION

The present application claims the benefit of U.S. Provisional Patent Application No. 63/581,927, filed on Sep. 11, 2023, and titled “PADDLE WITH REDUCED ACOUSTIC SIGNATURE AND IMPROVED VIBRATION DAMPING,” the disclosure of which is expressly incorporated by reference in its entirety.

### TECHNICAL FIELD OF THE INVENTION

The present disclosure relates generally to paddles, and more specifically, to a paddle, such as a pickleball paddle, with a reduced acoustic signature and improved vibration damping.

### BACKGROUND OF THE INVENTION

The sport of pickleball started in the 1960s as an alternative to tennis. Currently, pickleball is the fastest growing sport in the United States and will soon be an Olympic sport. In 2022, there were 3.8 million pickleball players in the U.S. As of 2023, it is estimated that over 8.7 million people are playing the sport. There are many factors that have contributed to the growth of the sport of pickleball, with the top of these being the social and physical benefits of the sport being a low impact sport compared to tennis and the social aspects of playing with four people.

In addition to its social and physical benefits, pickleball's growth can be attributed to its accessible and straightforward equipment. The game is played with a paddle, slightly larger than a ping-pong paddle, and a plastic ball with holes, often referred to as a wiffle ball. The court is approximately a quarter the size of a tennis court, making it less physically demanding and ideal for players of all ages. The net is slightly lower than a tennis net, and the game can be played in singles or doubles format, with doubles being the more popular. Pickleball combines elements of tennis, badminton, and table tennis, with players volleying the ball back and forth over the net, aiming to score points by landing the ball in the opponent's court. The sport's simple rules, quick learning curve, and the ability to play both indoors and outdoors have made it appealing to a wide audience, further fueling its rapid expansion across the country.

### SUMMARY OF THE INVENTION

Various aspects of the present disclosure are directed to a paddle for a reduced acoustic signature and improved vibration damping. The paddle may include thermoplastic resin systems that dampen vibration much more effectively then thermoset resins, and which provide for a lower acoustical signature as well as fewer vibrations that can cause tendonitis and other injuries from repetitive usage. The paddle may also include viscoelastic materials to further reduce the acoustic signature and provide additional vibration dampening.

In some examples, thermoplastic layers are formed into a “bull nose” shape over the outer edge of a core to eliminate the need for a plastic edge strip commonly found on the majority of pickleball paddles.

Additionally, or alternatively, in some examples, fibers connect laminate layers in a “Z” axis, through holes in a core to secure the laminate layers to the core and prevent the layers from peeling away from the core.

Additionally, or alternatively, in some examples, a core is adapted to have an increased density along the perimeter of the paddle head compared to a center portion of the paddle head to increase the Moment of Inertia (MOI), thus minimizing paddle twisting during off-center impacts.

### BRIEF DESCRIPTION OF DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is an isometric top and side perspective view of a complete pickleball paddle, in accordance with various aspects of the present disclosure.

FIG. 2 is an isometric exploded cross-sectional of the paddle of FIG. 1, including a two-piece grip handle, in accordance with various aspects of the present disclosure.

FIG. 3A is an isometric front and side view of the paddle cross-section of FIG. 1 showing the core and “Z” direction reinforcement, in accordance with various aspects of the present disclosure.

FIG. 3B is an isometric front and side view of the paddle cross-section of FIG. 1 showing composite skin layering, in accordance with various aspects of the present disclosure.

FIG. 3C is a transverse sectional view of the paddle of FIG. 1 showing the “Z” direction fiber, in accordance with various aspects of the present disclosure.

FIG. 3D is a transverse sectional view of the paddle cross-section of FIG. 1 showing that continuous fiber extends through the core and into the face sheet, in accordance with various aspects of the present disclosure.

FIG. 3E is an exploded transverse sectional view of the paddle cross-section of FIG. 1, in accordance with various aspects of the present disclosure.

FIG. 3F is an exploded transverse sectional view of the paddle cross-section of FIG. 1 depicting continuous fiber penetrating through the core and the skin layers, in accordance with various aspects of the present disclosure.

FIG. 4 is a plan view of the paddle core of FIG. 1 with the “Z” direction fiber holes, in accordance with various aspects of the present disclosure.

FIG. 5 is a plan view of a paddle core with the “Z” direction fiber holes around the paddle perimeter showing a different core material located inboard of said perimeter, in accordance with various aspects of the present disclosure.

FIG. 6 is a plan view of a paddle core with “Z” direction fiber holes around the paddle perimeter showing a layer of a different density material compared to the outer frame of the paddle, in accordance with various aspects of the present disclosure.

FIG. 7A is a plan view of a paddle core with “Z” direction fiber holes around the paddle perimeter, in accordance with various aspects of the present disclosure. The center detail shows a higher hole density in the center of the paddle in a rectangular shape extending from the paddle head to the paddle handle.

FIG. 7B is a plan view of a paddle core with “Z” direction fiber holes around the paddle perimeter, in accordance with various aspects of the present disclosure. The center detail shows a higher hole density in the center of the paddle in a circular shape extending from the paddle head to the paddle handle.

FIG. 7C is a plan view of a paddle core with “Z” direction fiber holes around the paddle perimeter, in accordance with various aspects of the present disclosure. The center detail shows a higher hole density in the center of the paddle in a square shape extending from the paddle head to the paddle handle.

FIG. 7D is a plan view of a paddle core with “Z” direction fiber holes around the paddle perimeter, in accordance with various aspects of the present disclosure. The center detail shows a higher hole density in the center of the paddle in a cross shape extending from the paddle head to the paddle handle.

FIG. 8A is an isometric top and side view of a paddle core with “Z” direction fiber holes throughout the entire core and an open section inboard of the paddle perimeter, in accordance with various aspects of the present disclosure.

FIG. 8B is an isometric top and side view of a paddle core with “Z” direction fiber holes throughout the entire core and a center section that is formed to create a recessed cavity that extends into the core from both the top and bottom side of the paddle core, in accordance with various aspects of the present disclosure.

FIG. 8C is a plan view of a paddle core showing an asymmetric shape that can be formed into the paddle core, in accordance with various aspects of the present disclosure.

FIG. 9A is a cross-sectional side view of a paddle showing a recessed pocket containing a different material in the paddle center, in accordance with various aspects of the present disclosure.

FIG. 9B is a cross-sectional side view of a pickleball impacting the paddle of FIG. 9A showing the compliant flexible paddle surface providing for a higher Coefficient of Restitution and increased ball speed, in accordance with various aspects of the present disclosure.

FIG. 10 is a cross-sectional side view of a pickleball impacting a stiff paddle surface with no deflection in the surface upon impact, in accordance with various aspects of the present disclosure.

FIG. 11 is an exploded isometric perspective of a pickleball paddle including layers of the paddle construction, in accordance with various aspects of the present disclosure.

FIG. 12A is a cross-sectional side view of a paddle showing the layering of the paddle including the core, in accordance with various aspects of the present disclosure. This exploded view depicts the layering before compaction and forming the paddle into its final shape.

FIG. 12B is a cross-sectional side view of the paddle of FIG. 12A showing the layering of the paddle including the center core, in accordance with various aspects of the present disclosure. This exploded view depicts the compacted structure after forming including a sealed edge around the entire paddle perimeter.

FIG. 13A is an isometric view of an American Society for Testing and Materials (ASTM) Climbing Drum Peel Test method, in accordance with various aspects of the present disclosure.

FIG. 13B is graphical representation of a data set of a variety of different commercially available paddles compared to the paddle construction disclosed in various aspects of the present disclosure, in accordance with various aspects of the present disclosure.

FIG. 14 is a graphical representation of the peak sound level created by the pickleball hitting the paddle surface at a prescribed input velocity, in accordance with various aspects of the present disclosure.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

A typical pickleball paddle generates a high frequency sound between 80 decibels (Db) to over 110 Db. Every increase of 6 Db in sound is a doubling of the sound pressure level, and any sound above 70 Db starts to cause pain and irritation to the human body. In addition to the amplitude of the peak frequency causing discomfort, the attenuation of the sound causes the sound to travel long distances. This has created serious noise complaint issues especially since most pickleball play occurs on outside courts. The problem gets exasperated when people play indoors, which enhances the negative effects on the body and the brain.

Unlike in the sport of tennis, where the tennis ball has a felt surface and is compliant when struck in addition to the racket having strings and is also compliant, the sport of pickleball utilizes a non-compliant hard plastic perforated ball along with a paddle that has a very rigid face. The combination of the hard ball striking a hard stiff face creates very harsh high frequency sound waves.

Some of the conventional solutions to address the issue of sound and sound attenuation in the sport of pickleball, include installing sound wall barriers that attach to the existing court fencing or even, in some cases, building brick and mortar sound walls. These types of solutions are very costly, require maintenance, and are only marginally effective. Some paddle manufacturers offer products that they claim are quiet paddles, but many of these do not meet the paddle stiffness minimum deflection values required by the International Pickleball Federation (IPF) and the U.S. Pickleball Association (USPBA).

In addition to noise being the number one problem with the sport of pickleball, the second most notable negative aspect of the sport is the high occurrence of tendinitis in the hands and elbows. With the explosion of the growth of the sport of pickleball, the associated incidence of medical injury has skyrocketed. It is reported that in 2022, the associated medical costs related to the sport of pickleball exceeded $400 million dollars. The number three reported cause of reported injuries is tendonitis. The tendonitis is caused by the hard plastic ball impacting a hard paddle surface. The vibrations caused by the ball impact travel from the paddle face into the handle, then into the hand, and eventually into the elbow region. These vibrations travel into the hand and elbow regions and inflame the tendons and surrounding tissue, creating a painful situation. What compounds this problem is that the repetitive nature of pickleball imparts 4 to 5 times the number of ball impacts in a typical match compared to tennis. It has become such an issue that doctors have termed it “pickleball elbow,” like tennis elbow. To address this issue, manufacturers have added things like fillers to the honeycomb core and the paddle handle to help reduce the vibrations, all with limited success.

Another common problem with pickleball paddles is that the materials utilized in current pickleball paddle construction rely on bonding thermoset epoxy face sheets to a core material made from a different material class. This means that the designs rely upon using an adhesive film or paste that joins the paddle face sheets to the core material. The peel strength of the paddles is continuing to be a rising issue, with the frequency of paddles failing in the field due to this issue has been increasing dramatically. When a player strikes the ground with their paddle, it imparts large loads concentrated on the edge of the paddle. This can cause paddle failure due to the face sheet skins delaminating from the core material. The industry solution to address this issue has been to incorporate a plastic edge strip that encapsulates the three sides of the edge of the paddle. These edge strips add weight and can create unpredictable ball flight if the ball strikes the area where the strip transitions to the face sheet. Despite paddles that utilize a plastic edge strip to protect the paddle, these paddles can still fail and delaminate if the impact force is large enough.

Various aspects of the present disclosure are directed to a paddle, such as a pickleball paddle, with a reduced acoustic sound signature and/or reduced vibrations. Aspects of the present disclosure are not limited to pickleball paddles and may be used for other types of paddles, bats, racquets, hitting devices, etc. As discussed, in some examples, the paddle is associated with a reduced acoustic sound signature and/or reduced or eliminated vibrations that are caused by a ball striking the face of the paddle. In some examples, a thermoplastic material, such as 100% thermoplastic material, may be used to reduce the acoustic sound signature. The thermoplastic materials provide for tough and edge durable designs, and allow for high-speed continuous lamination of the head itself. In some examples, the acoustic sound signature may be reduced by at least 6 dB. Reducing the vibrations may reduce the inflammation in the hands and elbow regions that cause tendonitis. Various aspects of the present disclosure are also directed to creating a laminate structure that improves the edge delamination properties of the paddle.

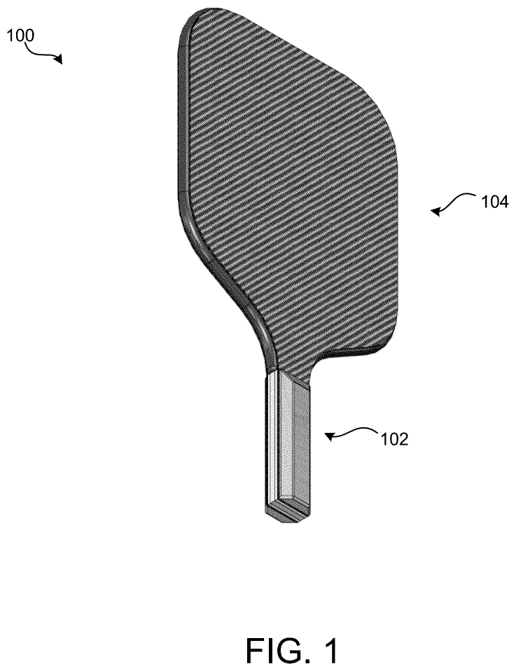

FIG. 1 illustrates an example of a paddle 100, in accordance with various aspects of the present disclosure. The paddle 100 includes a handle portion 102 and a head portion 104 having first and second sides. While the handle portion 102 is shown to be monolithic with the head portion 104, the handle portion 102 may also be made of a separate material and coupled to the head portion 104 via fasteners, adhesives, etc. The head portion 104 is shown to be substantially planar with a generally square shape having rounded corners. It would be appreciated that paddle heads 104 having different shapes may also be provided. The length, width, and thickness of the paddle head 104 are generally in accordance with the rules and regulations of pickleball associations. For example, USPBA rules state that the combined length and width, including any edge guard and butt cap, shall not exceed 24 inches (60.96 cm). The paddle length cannot exceed 17 inches (43.18 cm). The USPBA does not provide a restriction on paddle thickness. The thickness of the paddle head 104 may be selected based on the materials that are chosen and other desirable properties such as the overall weight of the paddle.

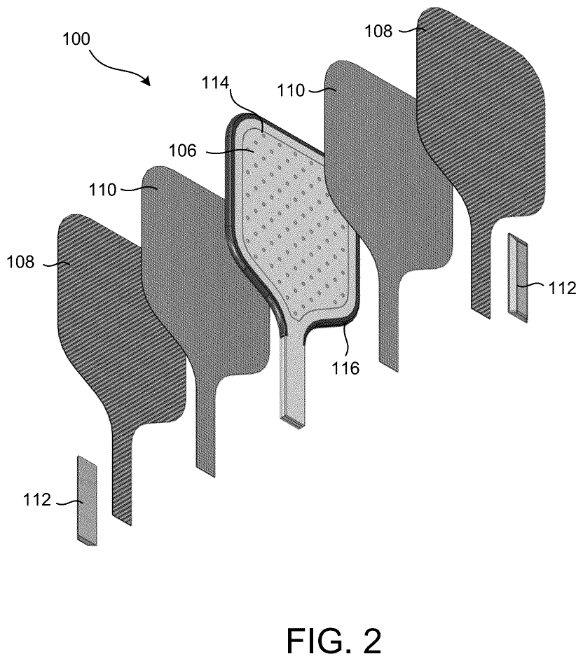

FIG. 2 illustrates an example of an isometric exploded cross-sectional of the paddle construction, in accordance with various aspects of the present disclosure. As shown in the example of FIG. 2, paddle 100 may include a core 106, laminate layers 108, and secondary layers 110 disposed between the sides of the core 106 and the laminate layers 108. The core 106 includes first and second sides that are substantially planar, and the core has a thickness measured between the first and second sides. The core 106 may be substantially solid, or it may be defined by a honeycomb pattern with openings between the first and second sides of the core 106. The density of the honeycomb (or another pattern) may be selected based on the desired stiffness and weight that is desired. The laminate layers 108 (also referred to as the first and second laminate layers) are coupled to the core 106, and typically form the outermost layers of the paddle 100, which are adapted to contact the ball used in the sport of pickleball. The laminate layers 108 may include a thermoplastic resin film with dye sublimation graphics, so that the head portion 104 of the paddle may include images or text.

The first and second sides of the head portion 104 preferably have the same construction so as to provide the same hit properties, but it is also possible that the first and second sides may be different, and have laminate layers 108 or secondary layers 110 that are made of different materials. The paddle 100 may also include grip bodies 112 on each of the sides of the core 106. The core 106 may include holes 114 and an outer edge 116 that extends substantially along the head portion 104 of the paddle 100. While the holes 114 are preferably substantially perpendicular to the planar faces of the core 106, it may be possible for the holes to pass through the core 106 at an angle relative to the planar faces of the head portion 104.

The laminate layers 108, the secondary layers 110, and the core 106 are substantially planar and are sandwiched together to form the paddle 100. The laminate layers 108 may be coupled to each other by Z-axis fibers 118 that couple to each of the laminate layers 108 and pass through the holes 114 of the core 106. The Z-axis fibers 118 may be thermally bonded to the laminate layers 108. These Z-axis fibers 118 provide superior mechanical shear strength compared to traditional bonding methods that rely on a film adhesive or two-part epoxy resin.

The Z-axis fibers 118 may be formed from glass fibers, carbon, aramid, and/or one or more other reinforcing fibers. The Z-axis fibers 118 may be formed using a Z-axis fiber deposition machine, such as the Z-axis fiber deposition machine described in U.S. Pat. No. 6,676,785, which is incorporated by reference. While the Z-axis fibers 118 are generally described as attached or coupled to the laminate layers, the Z-axis fibers may also extend into the laminate layers. For example, the Z-axis fibers may be inserted through the core 106 and the laminate layers 108, and the ends of the Z-axis fibers 118 may extend beyond the outer surfaces of both of the laminate layers 108, and then the ends of the Z-axis fibers 118 may be clinched and integrated into the laminate layers 108, as described in U.S. Pat. No. 6,676,785. The Z-axis fibers 118 may also be inserted through the laminate layers 108 and core 106 using a hollow tube, where the Z-axis fibers 118 are advanced in the hollow tube, and the hollow tube is removed, leaving the Z-axis fibers 118 in the desired location. The paddle 100 may be heated to couple the components of the paddle together.

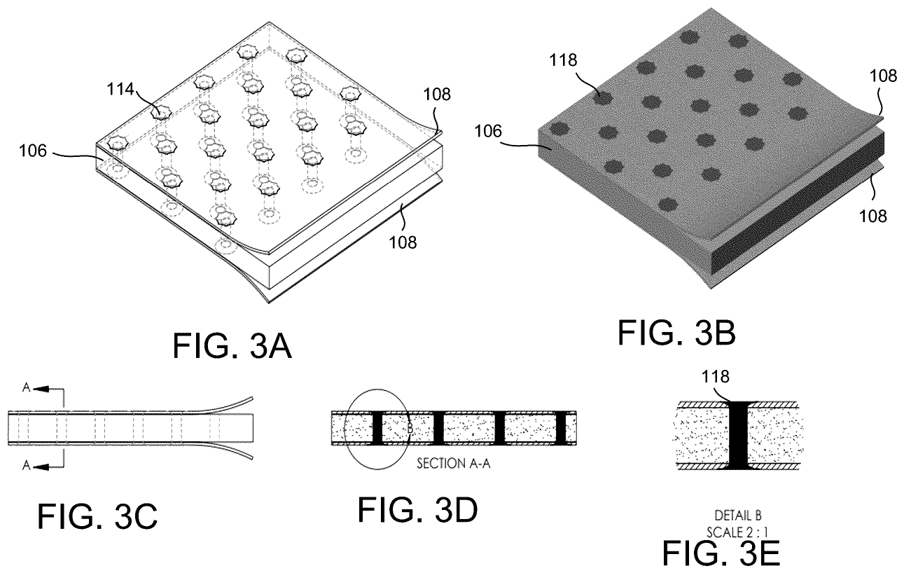

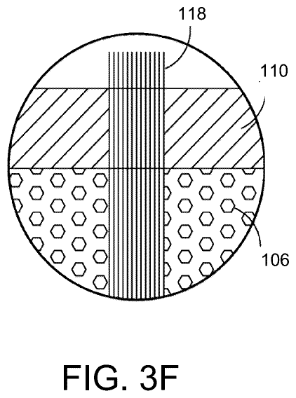

FIGS. 3A-3F illustrate portions of the core 106 and the laminate layers 108, which are connected by Z-axis fibers 118, in accordance with various aspects of the present disclosure. In FIG. 3F, a secondary layer 110 is shown, with the Z-axis fibers passing through an aperture in the secondary layer 110 to be able to connect to the corresponding laminate layer 108 (not shown in FIG. 3F). In some examples, the holes 114 and Z-axis fibers 118 may be placed in different arrangements throughout the head portion 104 along the planar faces of the core 106. For instance, the Z-axis fibers 118 can be placed only around the perimeter of the paddle head as a means of increasing the shear strength between the core 106 and the upper and lower laminate layers 108 at the edges of the paddle most susceptible to delamination. The increase in shear strength provides superior edge delamination properties that help prevent the laminate layers 108 from delaminating if the player strikes the ground with the paddle. The density of the holes 114 (that is, the number of holes in a given area) may also be varied to provide desired strength, as well as provide the desired weight distribution and overall weight of the paddle.

In other examples, the Z-axis fibers 118 can be oriented in the center of the head portion 104 and can have a higher stich density than the stitch density that is located around the paddle perimeter. This can provide for a centralized center section with a higher density and higher panel stiffness compared to the paddle perimeter. This increases the Coefficient of Restitution (COR) for the paddle, which results in higher ball speed and improved ball control.

The core 106 and laminate layers 108 may be formed of various materials suitable for paddle construction. In various aspects, the materials are selected to reduce the acoustic signature of the paddle. The core 106 may be formed from a low density thermoplastic closed cell foam with a density in the range of 2.5 pounds per cubic foot. The core 106 is not limited to a closed cell foam core, but can include all types of core materials like Nomex honeycomb and thermoplastic polyurethane (TPU) honeycomb. Other aspects of the present disclosure use a lightweight/low density closed cell foam as a core material to reduce the acoustic signature or noise of the paddle. The laminate layers 108 may be formed from thermoplastic resins, which may include pre-preg fibers. The laminate layers 108 may be formed of a single layer, or multiple layers that are stacked together and/or thermoformed together.

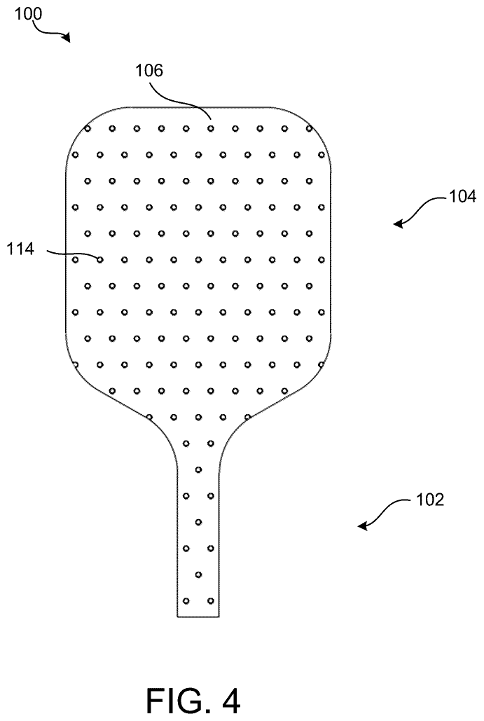

FIG. 4 illustrates an example of a paddle 100, in accordance with various aspects of the present disclosure. In the example of FIG. 4, first and second sides of the head portion 104 may have the same construction so as to provide the same hit properties, but it is also possible that the first and second sides may be different. The core 106 may include holes 114 that may be substantially perpendicular to the planar faces of the core 106. In other examples, the holes 114 may pass through the core 106 at an angle relative to the planar faces of the head portion 104.

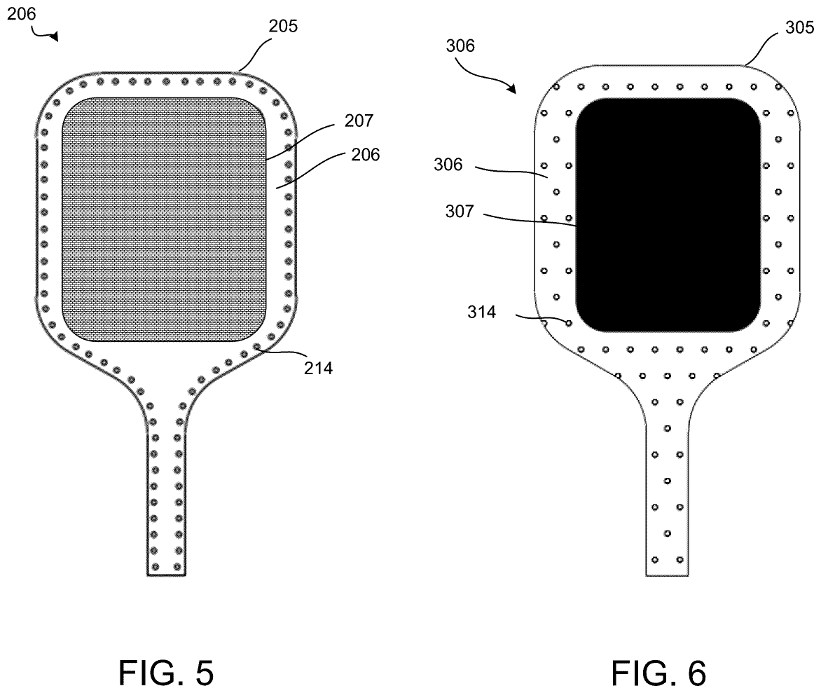

FIGS. 5-8C illustrate examples of various core configurations, in accordance with various aspects of the present disclosure. In the examples of FIGS. 5-8C, arrangements and density of the holes in the core may be provided to provide the desired stiffness characteristics, and to increase the sheer strength of the laminate layers. FIG. 5 illustrates an example of a core 206. The core 206 is formed of a first material that is continuous around the perimeter of the core 206. Holes 214 are present along the perimeter proximal to the outer edge 205 of the core 206, and the holes 214 are arranged in a linear fashion. The core 206 includes a center core portion 207 that is formed from a material that is different than the core 206 along the perimeter of the core 206, located inboard of said perimeter. It would be understood that the dimensions and shape of the second core portion 207 may be selected to provide desirable weight properties. The center core portion 207 may have a lower density than that of the core 206. For enhanced gameplay, a Moment of Inertia (MOI) may be increased by using a denser core 206 material relative to the material of the center core portion 207, thus minimizing paddle twisting during off-center impacts. The holes 214 and corresponding fibers (not shown) positioned around the core's perimeter may serve a dual purpose: preventing edge delamination and increasing MOI by providing increased weight proximal to the outer edge 205 of the core 206, and the resulting paddle. It would also be understood that the dimensions of the center core portion 207 may be selected to provide an increased MOI, while also providing a suitable hitting face for contacting the ball.

The example shown in FIG. 6 includes similar features to the core 206 shown in FIG. 5. The core 306 is formed of a first material that is continuously around the perimeter of the core 306. Holes 314 are present on the core 306 is a substantially uniform distribution along the surface of the core 306. The core 206 includes a center core material 307, located inboard of said perimeter. The second core material 307 may have a lower density than that of perimeter portion of the core 306.

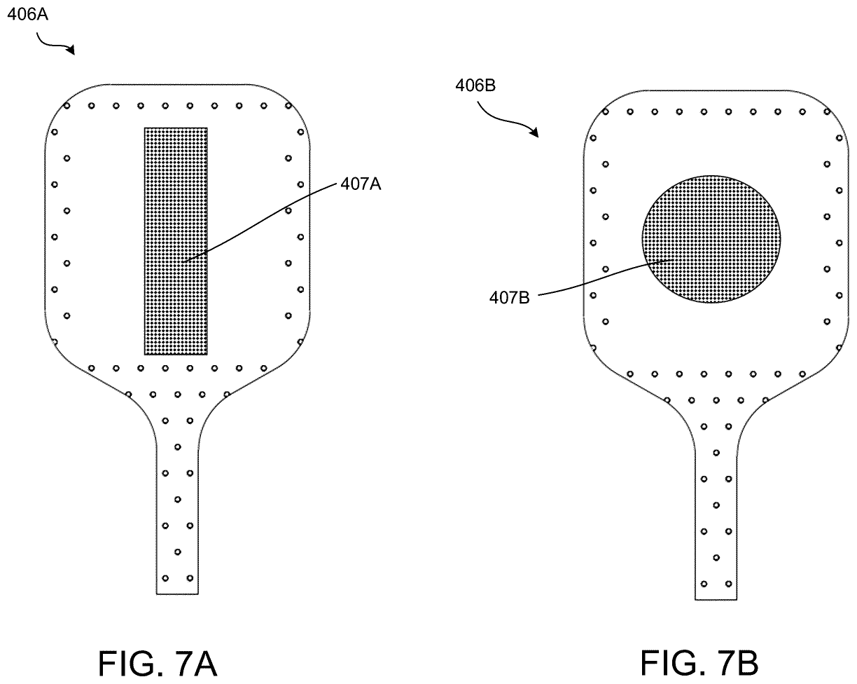

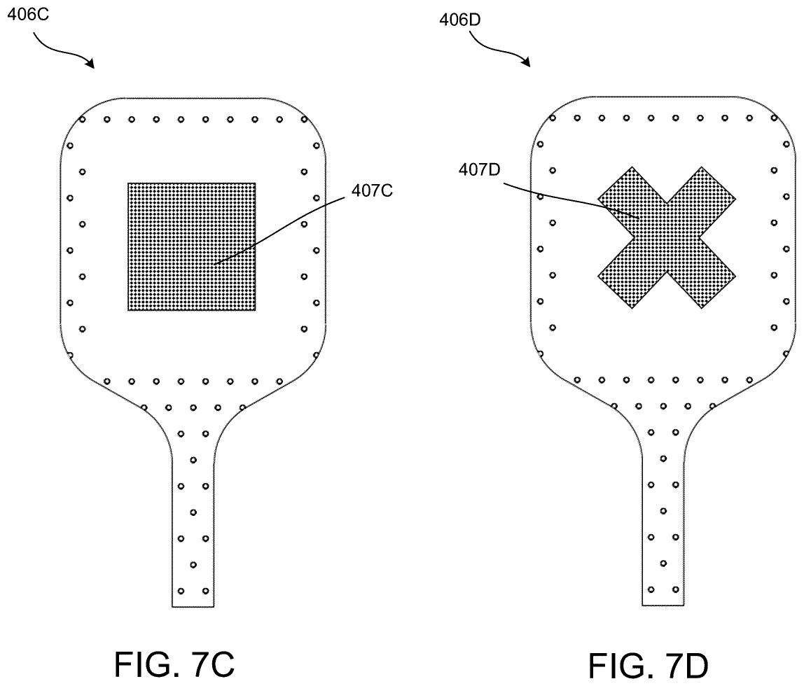

FIGS. 7A-7D show additional examples of the paddle with various geometric arrangements of holes, in accordance with various aspects of the present disclosure. FIG. 7A shows a core 406A having a center portion 407A with a higher hole density, adapted for an increased Z-axis fiber concentration, where the center portion 407A is a rectangular shape extending from the handle portion toward the top of the paddle. FIG. 7B shows a core 406A having a center portion 407B with a higher hole density, adapted for an increased Z-axis fiber concentration, where the center portion 407B is a circular shape. FIG. 7C shows a core 406C having a center portion 407C with a higher hole density, adapted for an increased Z-axis fiber concentration, where the center portion 407C is a square shape. FIG. 7D shows a core 406D having a center portion 407D with a higher hole density, adapted for an increased Z-axis fiber concentration, where the center portion 407D is a cross shape. Other shapes of the center portions may also be provided.

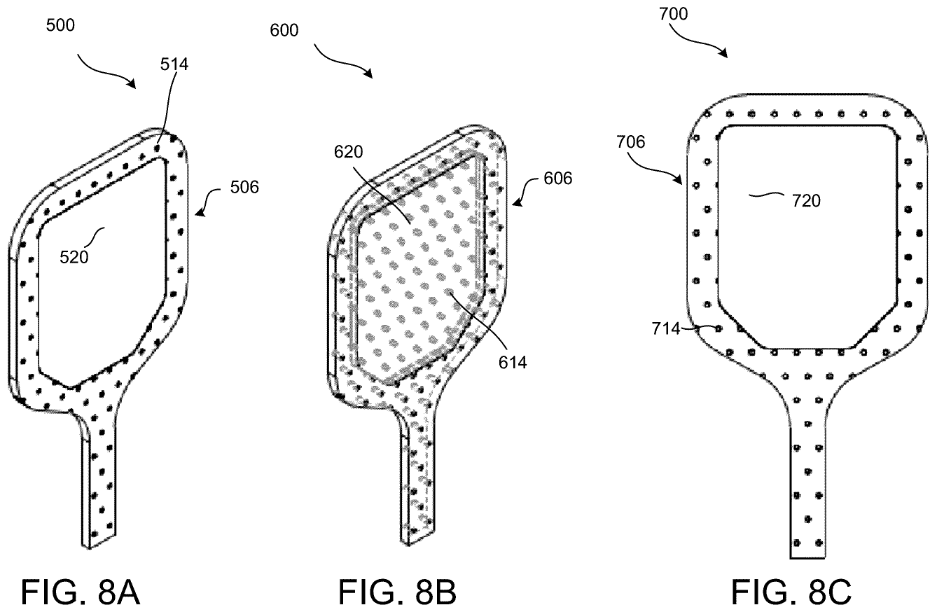

FIG. 8A illustrates an example of a core 506 that may be used in one or more examples of a paddle 500, in accordance with various aspects of the present disclosure. In the example of FIG. 8A, the core 506 includes an open section 520 that is formed within the perimeter of the core 506. Holes 514 are disposed in the perimeter of the core 506. While not shown in FIG. 8A, it would be appreciated that Z-axis fibers (such as Z-axis fibers 118 described above) may connect laminate layers (such as laminate layers 108 described above) disposed on each side of the core 506, including Z-axis fibers that pass through the holes 514 as well as the open section 520. The density of Z-axis fibers that pass through the open section 520 may be arranged at a desired density. The shape of the open section 520 may be any geometric or irregular shape. The width of the perimeter portion of the core 506 (measured from the outer edge of the core 506 to the inner portion 520) is selected to provide stability for the paddle, as well as the desired weight distribution and overall weight. As explained above, the Moment of Inertia (MOI) of the paddle may be increased by using a denser material along the perimeter of the core compared to a center portion of the core. By providing an open section 520, the center portion of the paddle is less dense, increasing the MOI to minimize paddle twisting during off-center impacts. In some examples, the paddle 500 can support all the structural loads with the Z-axis fiber reinforcement, so a very lightweight/low density foam may be used in the core 506 to provide for not only improved sandwich panel mechanical properties, but a reduced sound transmission as well.

FIG. 8B illustrates an example of core 606 that may be used in one or more examples of a paddle 600, in accordance with various aspects of the present disclosure. In the example of FIG. 8B, the core 606 includes a recessed cavity 620 on each side of the core 606. The shape of the recessed cavity 620 may be any geometric or irregular shape. Holes 614 are distributed across the surface of the core 606, including the portion of the core 606 with the recessed cavity 620 on each side.

FIG. 8C illustrates an example of a core 706 that may be used in one or more examples of a paddle 700, in accordance with various aspects of the present disclosure. In the example of FIG. 8C, the core 706 includes a recessed cavity 720 on each side of the core 706. The shape of the recessed cavity 720 may be any geometric or irregular shape. Holes 714 are distributed across the surface of the core 706, but are not present on the portion of the core 706 that includes the recessed cavity 720.

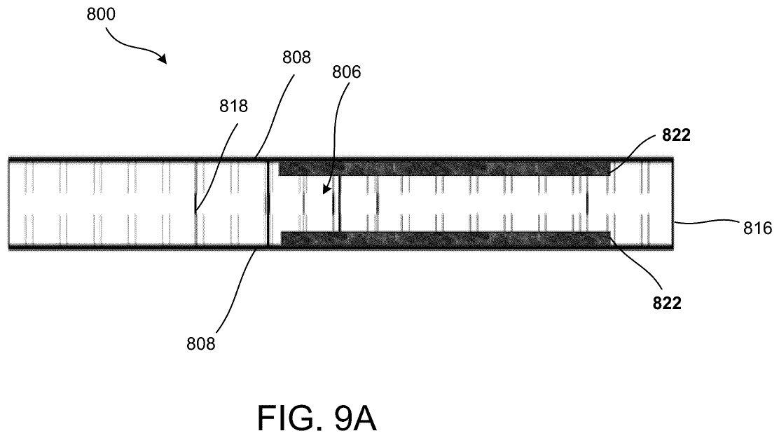

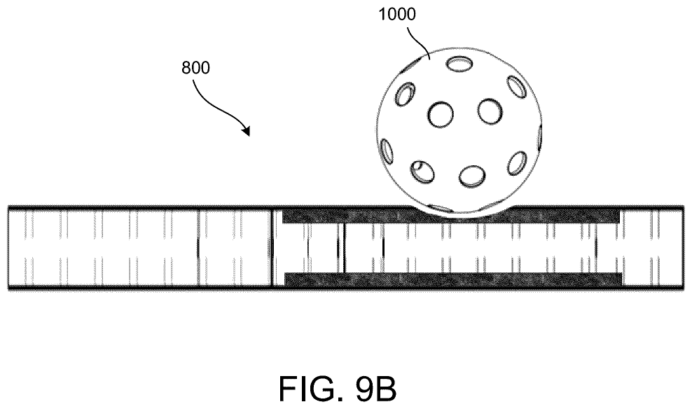

FIGS. 9A and 9B illustrate an example of a paddle 800, in accordance with various aspects of the present disclosure. In the example of FIGS. 9A and 9B, the paddle includes a core 806 having an outer edge 816, where the core 806 is sandwiched between laminate layers 808, and a secondary layer 822 disposed in a recessed cavity similar to the recessed cavity 620 as shown in the embodiment of FIG. 8B. The secondary layer may be formed of a viscoelastic material. The viscoelastic material may include cork, SORBOTHANER, thermoplastic resins, ethylene propylene diene monomer (EPDM) rubber, natural rubbers, and urethanes. A Coefficient of Restitution (COR) may be increased based on the use of viscoelastic materials as a secondary layer 822 employed in the construction. This results in a more compliant face, while also ensuring the paddle offers a higher exit speed. Furthermore, a spin rate may be increased based on increased skin compliance because the longer period of contact, and larger surface area of contact with the ball allows players to spin the ball more effectively. Additionally, the secondary layer 822 may be used for vibration damping to reduce the acoustic signature and the vibrational effects leading to injuries such as tendonitis. The secondary layer can vary in thickness, durometer, and/or density to achieve desired properties. FIG. 9B shows a ball 1000 contacting the paddle 800 at the compliant surface, and partially deforming the surface.

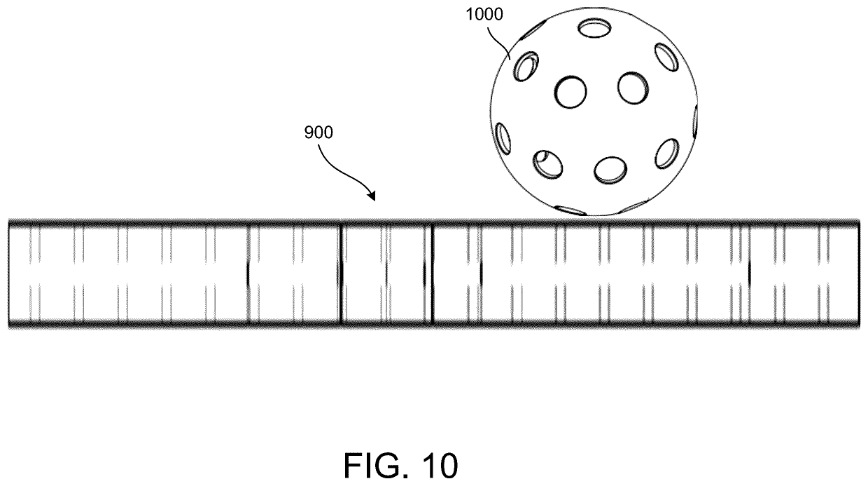

FIG. 10 illustrates an example of a paddle 900 that has a stiff surface in comparison to the compliant surface of the paddle 800, as shown in FIG. 9B, in accordance with various aspects of the present disclosure.

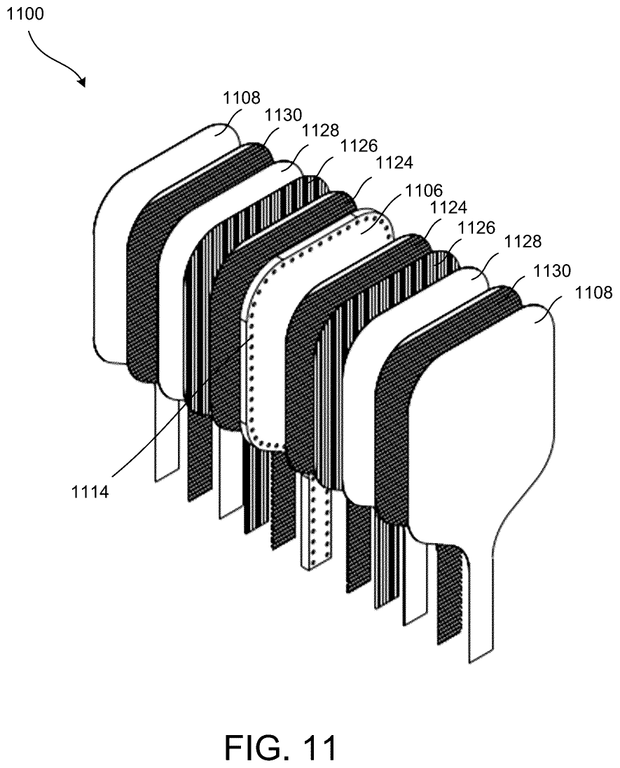

FIG. 11 illustrates another example of a paddle 1100 that includes a core 1106 having holes 1114 extending through the core 1106 between first and second sides of the core 1106, in accordance with various aspects of the present disclosure. Layers may be coupled to the first and second sides of the core 1106, including laminate layers 1108, which form the outermost layer of the paddle 1100. The laminate layers 1108 may be formed of thermoplastic. Additional layers of fiber-reinforced thermoplastic resin may also provided, which are thermally bonded to the core 1106 that is formed of thermoplastic. The additional layers (also referred to as “secondary layers”) may include a second thermoplastic layer 1124, a third thermoplastic layer 1126, a fourth thermoplastic layer 1128, and a fifth thermoplastic layer 1130. It would be appreciated that greater or fewer of the additional layers could be provided. The laminate layers 1108 and the additional layers may include pre-preg materials that include fibers in a polymer matrix, and the polymer matrix may include thermoplastics. The fibers in each of the additional layers may be unidirectional within each layer, and the additional layers may be arranged such that the direction of the fibers in each additional layer is different than the direction of the other layers. Alternatively, some or all of the directions of the fibers in the various layers may be the same. Thermoplastic resins offer several advantages over thermoset resins that are currently used in the construction of pickleball paddles. Thermoplastic resins require a shorter cure time, so more components can be produced per time period. Thermoplastic resin systems dampen vibration much more effectively than thermoset resins, which provide for a lower acoustic signature and fewer vibrations that can cause tendonitis.

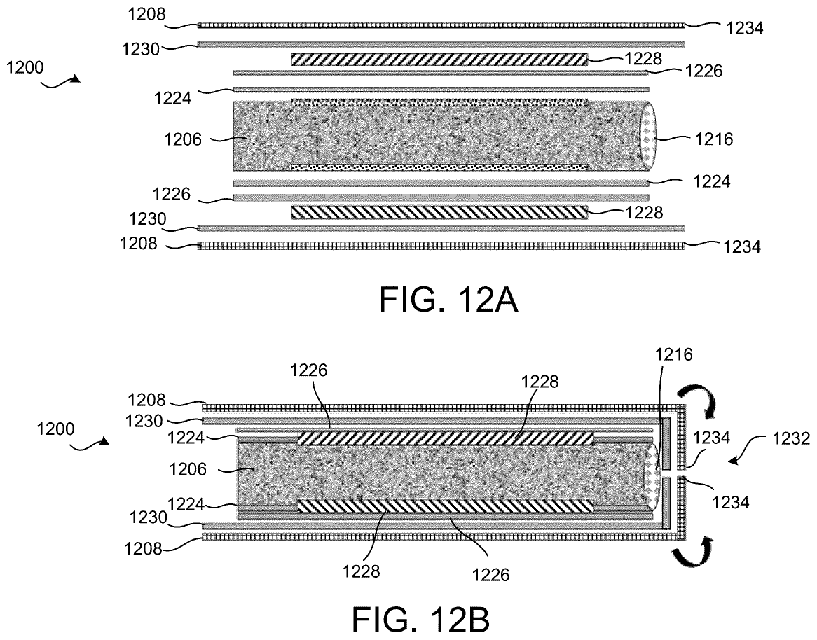

Thermoplastic resins are also tougher and would not require a bumper guard to protect the laminate layers of a paddle. In an embodiment, referring to FIGS. 12A and 12B, the paddle 1200 includes a core 1206 and additional layers similar to the additional layers of paddle 1100 shown in FIG. 11. The additional layers include second thermoplastic layer 1224, a third thermoplastic layer 1226, a fourth thermoplastic layer 1228, and a fifth thermoplastic layer 1230. Laminate layers 1208 are form the outermost layer of the paddle 1200. As shown in FIG. 12B, the laminate layers 1208 and the fifth thermoplastic layers 1230 are formed around the outer edge 1216 of the core 1206. It would be appreciated that a greater or fewer number of the additional layers may be formed over the outer edge 1216 of the core. By forming the laminate layers 1208 and/or the additional layers over the outer edge 1216, a bumper is not required. The laminate layers 1108 include laminate edges 1234, and these laminate edges 1234 may be fused together to form a closed end 1232. Further, the thermoplastic resin systems are tougher, and may better withstand forces to the edge of the paddle, such as when a paddle edge strikes the ground.

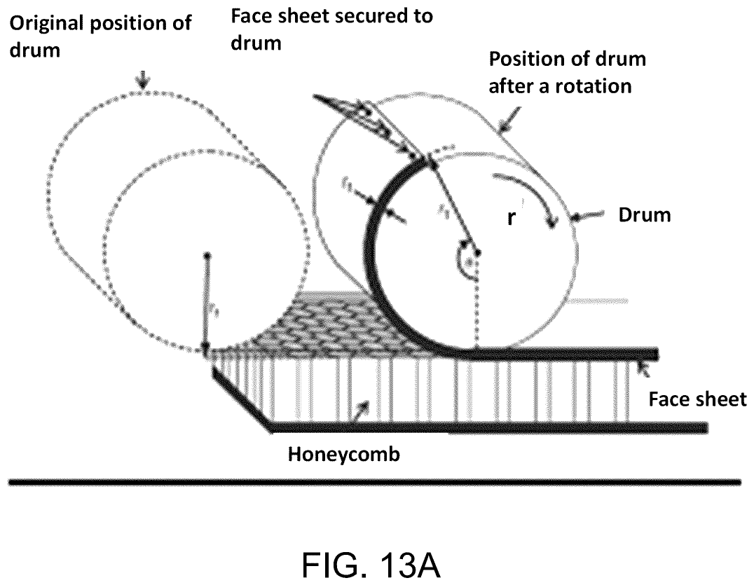

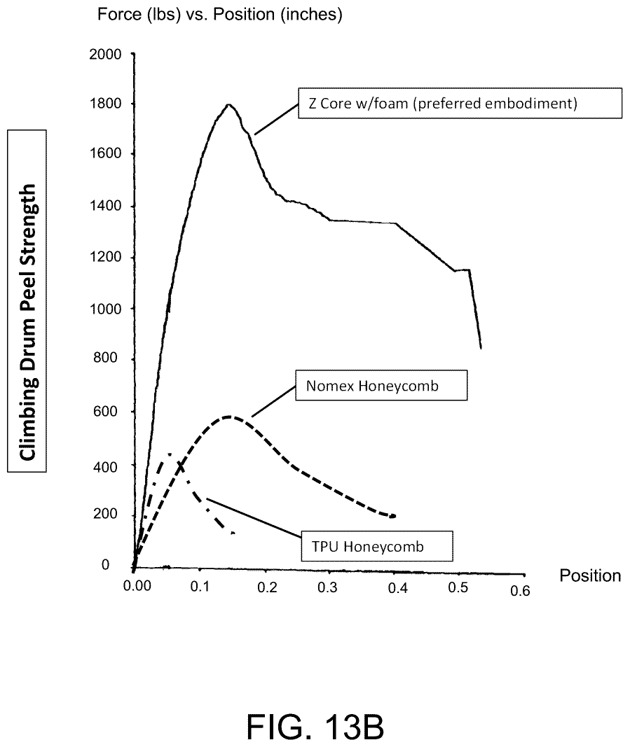

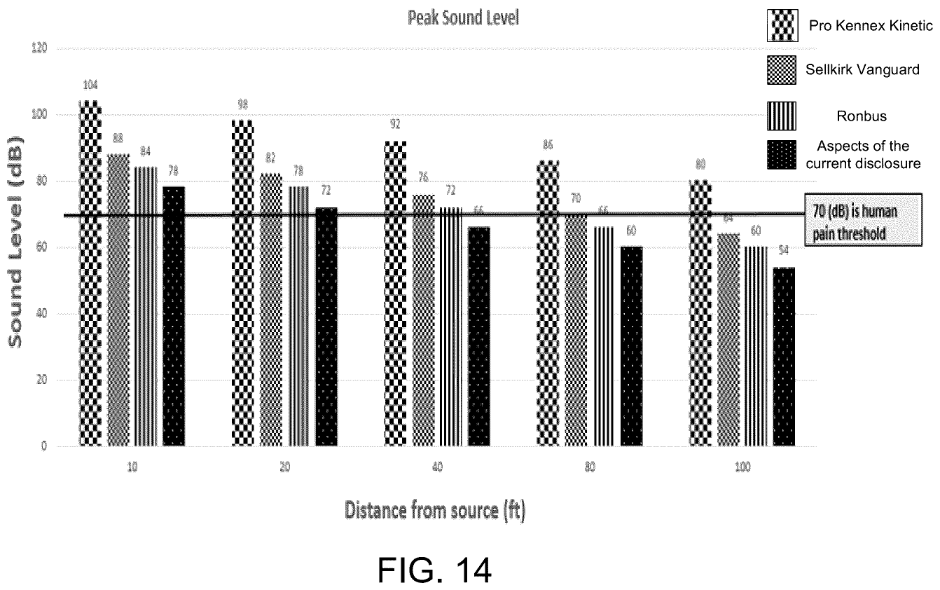

FIGS. 13A and 13B illustrate examples of the use of Z-axis fibers connecting the laminate layers of a paddle through a core, in accordance with various aspects of the present disclosure. The data is generated using an ASTM standard climbing drum peel test procedure (shown in FIG. 13A), which measures the strength of the bond between the skin materials of a paddle and the core material of the paddle. In the embodiment tested in FIG. 13B, the paddle included a thermoplastic foam core having holes in the Z-axis, with Z-axis fibers holding the laminate layer to the thermoplastic foam core. As shown in the graph of FIG. 13B, the laminate layer of the preferred embodiment was retained to the core at a higher strength than face sheets of a paddle with a Nomex honeycomb core or a thermoplastic polyurethane (TPU) core. This preferred embodiment also demonstrated a reduced sound level compared to existing pickleball paddles, as shown in FIG. 14. In FIG. 14, the peak frequencies of the three commercially available paddles (PRO KENNEX® Kinetic, SELKIRK SPORT® Vanguard, and RONBUS® EV2) are compared to various aspects of the present disclosure are plotted along the Y axis. Specifically, in the example of FIG. 14, the peak frequencies of the commercially available paddles compared to various aspects of the present disclosure are plotted along the Y axis, and the loss of sound pressure over distance is plotted along the Y axis. As shown in FIG. 14, the commercially available paddles produced a sound level greater than the 70 dB sound threshold, even at 40 feet away from the pickleball contact. At each measured distance, the paddle according to the various aspects of the present disclosure produces a lower sound than the commercially available paddles that were tested.

Various aspects of the present disclosure are directed to a process for manufacturing a paddle, such as a pickleball paddle, with enhanced structural integrity and performance. In some examples, the process may begin by constructing a core with first and second sides, an outer edge being defined between these sides, and a series of holes extending through the core from one side to the other. This core may be coupled with a first laminate layer on the first side and a second laminate layer on the second side. Fibers are inserted through at least one of the holes in the core, connecting the first and second laminate layers. The laminate layers may be fused together at their edges, particularly over the outer edge of the core. In some examples, the laminate layers are thermoplastic material. Additionally, or alternatively, the laminate layers may be formed from pre-preg fibers embedded in a thermoplastic resin, providing additional strength and rigidity.

In some examples, handle, continuously connected to the core, may be incorporated into the design. The core itself may be composed of a thermoplastic material with a density of less than or equal to 5.0 lbs/cu ft, optimizing the paddle's weight and performance. Additionally, the core may feature an open section surrounded by a perimeter portion, or a center portion made of a material with a different density than the rest of the core. The holes in the core are strategically arranged, with a higher density of holes located around the outer perimeter of the core compared to the inner area, which enhances the overall stability and performance of the paddle. Secondary layers, also made of pre-preg fibers in a thermoplastic resin, may be added to further reinforce the paddle's structure.

In other examples, the process may begin by constructing a core with first and second sides and then layering the core with first and second laminate layers on each respective side. Between the core and the laminate layers, first and second secondary layers are incorporated. The first and second secondary layers may be a viscoelastic material. These viscoelastic secondary layers improve the paddle's shock absorption and overall comfort during use.

In such examples, the core may be designed with a recessed cavity on each of its sides, allowing the laminate layers to extend into these cavities for added structural integrity. The viscoelastic material used in the secondary layers can be selected from a variety of materials, including cork, SORBOTHANE, thermoplastic resins, EPDM, natural rubbers, and urethanes, or combinations thereof, depending on the desired characteristics of the paddle. Furthermore, the laminate layers may be made from a pre-preg thermoplastic material, which provides strength and durability while maintaining a lightweight construction. This combination of materials and design features results in a paddle that offers a balance of flexibility, strength, and comfort.

In other examples, the process begins by forming a core made from thermoplastic material, which has first and second sides with an outer edge between them. This core is then covered on each side with first and second laminate layers, both of which include pre-preg thermoplastic material and have laminate edges that extend to the outer edge of the core. Additionally, first and second secondary layers, also made from pre-preg material, are applied to the respective sides of the core. The edges of the first and second laminate layers are fused together over the outer edge of the core, ensuring a strong and durable connection.

The core is designed with holes that align with apertures in the secondary layers, allowing Z-axis fibers to pass through. These fibers serve to connect the first and second laminate layers together, enhancing the structural integrity of the paddle. The pre-preg material used in both the laminate and secondary layers contains unidirectional fibers, which are oriented in specific directions to optimize the paddle's performance. The fibers in the first and second laminate layers are aligned in one direction, while the fibers in the secondary layers are aligned in a different direction, providing a balanced combination of strength and flexibility.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A paddle, comprising:
a core having first and second sides, an outer edge between the first and second sides, and holes extending through the core from the first side to the second side;
a first laminate layer coupled to the first side;
a second laminate layer coupled to the second side; and
fibers that respectively extend through at least one of the holes, wherein the fibers are coupled to the first and second laminate layers.

2. The paddle of claim 1, wherein the first and second laminate layers are thermoplastic.

3. The paddle of claim 2, wherein the first and second laminate layers include laminate edges, and the laminate edges are fused together.

4. The paddle of claim 1, further comprising a handle, wherein the handle is continuously connected to the core.

5. The paddle of claim 2, wherein the laminate layers are formed of pre-preg fibers in a thermoplastic resin.

6. The paddle of claim 2, wherein the first and second laminate layers each have laminate edges, and the laminate edges of the first and second laminate layers are fused together over the outer edge of the core.

7. The paddle of claim 5, further comprising secondary layers, wherein the secondary layers include pre-preg fibers in the thermoplastic resin.

8. The paddle of claim 1, wherein the core includes a thermoplastic material.

9. The paddle of claim 8, wherein the core has a density of less than or equal to 5.0 lbs/cu ft.

10. The paddle of claim 1, wherein the core includes an open section, and the open section is surrounded by a perimeter portion of the core.

11. The paddle of claim 1, wherein the core includes a center portion, and the center portion is formed of a material with a different density than the material of the core.

12. The paddle of claim 1, wherein the holes are arranged on the core such that an outer perimeter of the core includes a higher hole density than an area of the core that is inward to the outer perimeter.

13. A paddle, comprising:
a core having first and second sides;
first and second laminate layers respectively disposed on the first and second sides of the core; and
first and second secondary layers disposed between the core and the respective first and second laminate layers, wherein the secondary layers include a viscoelastic material.

14. The paddle of claim 13, wherein the core includes a recessed cavity on each of the first and second sides, and the laminate layers extend into the recessed cavity.

15. The paddle of claim 13, wherein the viscoelastic material is a material selected from a group consisting of: cork, SORBOTHANE, thermoplastic resins, EPDM, natural rubbers, and urethanes, and combinations thereof.

16. The paddle of claim 13, wherein the first and second laminate layers include pre-preg thermoplastic material.

17. A paddle, comprising:
a core having first and second sides and an outer edge between the first and second sides, wherein the core includes a thermoplastic material;
first and second laminate layers each having laminate edges, and the first and second laminate layers are respectively coupled to the first and second sides of the core, wherein the laminate layers include pre-preg thermoplastic material;
first and second secondary layers respectively coupled to the first and second sides of the core, wherein the secondary layers include pre-preg material; and
the laminate edges of the first laminate layer are fused to the laminate edges of the second laminate layer over the outer edge of the core.

18. The paddle of claim 17, wherein:
the core includes holes, and the secondary layers include apertures; and
the paddle further comprises Z-axis fibers connecting the first and second laminate layers together, wherein the Z-axis fibers pass through the holes in the core and the apertures in the secondary layers.

19. The paddle of claim 17, wherein pre-preg material includes fibers that are unidirectional in each of the laminate layers and secondary layers.

20. The paddle of claim 19, wherein first fibers of the first and second laminate layers face in a first direction, and second fibers of the secondary layers face in a second direction that is different than the first direction.
